(19) United States
(12) Patent Application Publication
(10) Pub. No.: US 2013/0265272 A1
(43) Pub. Date: Oct. 10, 2013

(54) TOUCH DISPLAY PANEL

(71) Applicants: Chao-Sung Li, Hsinchu County (TW); Lien-Hsin Lee, Taipei City (TW); Chia-Ming Hsieh, Keelung City (TW)

(72) Inventors: Chao-Sung Li, Hsinchu County (TW); Lien-Hsin Lee, Taipei City (TW); Chia-Ming Hsieh, Keelung City (TW)

(73) Assignee: SHUN ON ELECTRONIC CO., LTD., Hsinchu County (TW)

(21) Appl. No.: 13/491,615

(22) Filed: Jun. 8, 2012

(30) Foreign Application Priority Data
Apr. 6, 2012 (TW) 101112265

(51) Int. Cl. G06F 3/042; G06F 3/044; G06F 3/045

(52) U.S. Cl. 345/174

(57) ABSTRACT

A touch display panel including a substrate, a touch unit, a display unit, a circuit film and a flexible circuit board is provided. The substrate has a display region and a peripheral region surrounding the display region. The touch unit is disposed on the substrate and located in the display region. The display unit is disposed on the touch unit and located in the display region of the substrate. The circuit film is disposed on the substrate and located in the peripheral region, wherein the circuit film is electrically connected to the touch unit, and the circuit film has a plurality of key patterns. The flexible circuit board is electrically connected to the touch unit and the circuit film.

### CROSS-REFERENCE TO RELATED APPLICATION

This application claims the priority benefit of Taiwan application serial no. 101112265, filed on Apr. 6, 2012. The entirety of the above-mentioned patent application is hereby incorporated by reference herein and made a part of this specification.

### BACKGROUND OF THE INVENTION

1. Field of the Invention

The present invention generally relates to a touch display panel, and more particularly, to a touch display panel having integrated different operating interfaces.

2. Description of Related Art

In recent years, as digital information technology and wireless mobile communication have been rapidly developed and widely applied, input devices for a great many electronic products such as mobile phones, personal digital assistances (PDA), smart phones or the like have been changed from conventional keyboards or mice to touch panels for the purposes of convenience. Touch panels have become novel types of user interfaces and multi-media interactions, and paid much attention and developed in considerable quantities due to the convenience and operating instincts.

However, as to most of the electronic products, even though touch panel is disposed thereon as a sensing input device, there are still other mechanical keys disposed on the electronic products as a mechanical input device. Take a smart phone as an example, there is a display panel having a touch sensing function disposed thereon as a sensing input and display device, so that users can operate the smart phone by touch sensing. However, there are some mechanical keys having mechanical functions, such as power key or volume adjustment keys, disposed on the body of the smart phone as input devices. Disposing the aforementioned different types of operating interfaces on the electronic product may result in complicated fabricating process. In addition, when the different sorts of operating interfaces are disposed in the electronic product, the interoperability of the different operating interfaces is also an important factor to be considered.

### SUMMARY OF THE INVENTION

The present invention provides a touch display panel, wherein different sorts of operating interfaces are integrated on a substrate, thus the complexity and fabricating cost of the production of touch display panel can be reduced.

The present invention provides a touch display panel including a substrate, a touch unit, a display unit, a circuit film and a flexible circuit board. The substrate has a display region and a peripheral region surrounding the display region. The touch unit is disposed on the substrate and located in the display region. The display unit is disposed on the touch unit and located in the display region of the substrate. The circuit film is disposed on the substrate and located in the peripheral region, wherein the circuit film is electrically connected to the touch unit, and the circuit film has a plurality of key patterns. The flexible circuit board is electrically connected to the touch unit and the circuit film.

According to an exemplary embodiment of the present invention, the touch unit includes a capacitance touch unit, a resistance touch unit, an optical touch unit, a sound wave touch unit or an electromagnetic touch unit.

According to an exemplary embodiment of the present invention, the capacitance touch unit includes a plurality of first sensing series and a plurality of second sensing series. The first sensing series are arranged in a first direction. The second sensing series do not contact the first sensing series and arranged in a second direction, and the first direction and the second direction are intersected.

According to an exemplary embodiment of the present invention, each of the first sensing series comprises a first stripe electrode, and each of the second sensing series comprises a second stripe electrode.

According to an exemplary embodiment of the present invention, each of the first sensing series includes a plurality of first sensing pads and a plurality of first bridge lines serially connecting the first sensing pads along the first direction. Each of the second sensing series comprises a plurality of second sensing pads and a plurality of second bridge lines serially connecting the second sensing pads along the second direction.

According to an exemplary embodiment of the present invention, the circuit film further has a plurality of conductive wires. The conductive wires are electrically connected between the touch unit and the flexible circuit board, between the touch unit and the key patterns, and between the key patterns and the flexible circuit board.

According to an exemplary embodiment of the present invention, the conductive wires are formed by utilizing a printing method.

According to an exemplary embodiment of the present invention, each of the key patterns includes a number pattern, an alphabet pattern or a symbol pattern.

According to an exemplary embodiment of the present invention, the substrate includes a flexible substrate or a rigid substrate.

According to an exemplary embodiment of the present invention, the display region of the flexible substrate includes a first display region and a second display region. The peripheral region of the flexible substrate includes a first peripheral region, a second peripheral region and a third peripheral region which surround the first display region, and a connecting region connecting the first display region and the second display region. The first display region and the second display region are disposed back to back. The first peripheral region, the second peripheral region, the third peripheral region and the connecting region encloses side edges of the first display region and side edges of the second display region.

In light of the above, the touch display panel of the embodiment of the present invention has the touch unit and the display unit disposed in the display region of the substrate and the circuit film disposed in the peripheral region of the substrate. Namely, according to the touch display panel of the embodiment of the invention, different types of operating interfaces are integrated on the same substrate. Therefore, the touch display panel of the present invention has both display interface and operating interface to satisfy with the real requirements of applications, and the complexity and fabricating cost of the production of touch display panel can also be reduced.

In order to make the aforementioned and other features and advantages of the invention more comprehensible, embodiments accompanying figures are described in detail below.

### BRIEF DESCRIPTION OF THE DRAWINGS

The accompanying drawings constituting a part of this specification are incorporated herein to provide a further understanding of the invention. Here, the drawings illustrate embodiments of the invention and, together with the description, serve to explain the principles of the invention.

FIG. 1 is a schematic view of a touch display panel according to one exemplary embodiment of the present invention.

FIG. 2 is a schematic view of a touch display panel according to another exemplary embodiment of the present invention.

FIG. 3 is a schematic view of a touch display panel according to another exemplary embodiment of the present invention.

FIG. 4 is a schematic view of a touch display panel according to another exemplary embodiment of the present invention.

FIG. 5 schematically shows a perspective view of the touch display panel of FIG. 4.

### DESCRIPTION OF EMBODIMENTS

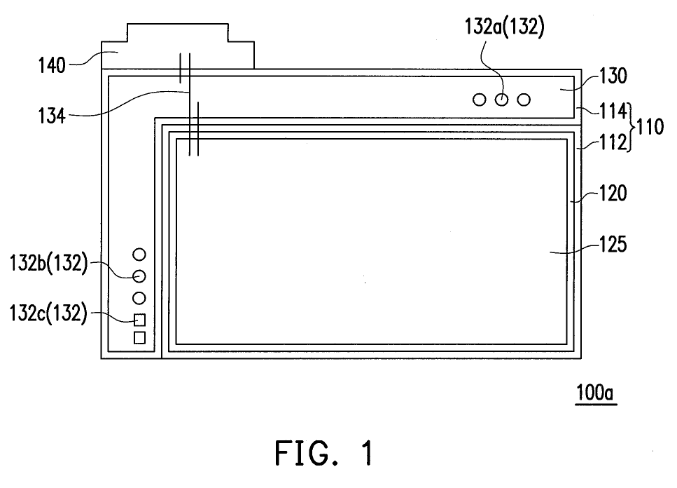

FIG. 1 is a schematic view of a touch display panel according to one exemplary embodiment of the present invention. Referring to FIG. 1, the touch display panel 100a of the embodiment includes a substrate 110, a touch unit 120, a display unit 125, a circuit film 130 and a flexible circuit board 140. The substrate 110 has a display region 112 and a peripheral region 114 surrounding the display region 112. In the embodiment, the display region 112 is a rectangle, and the peripheral region 114 surrounds two sides of the display region 112, as shown in FIG. 1. However, the touch display panel 100a can change the shape and location of the display region 112 and the peripheral region 114 according to requirements, and the present invention is not limited thereto.

Next, the touch unit 120 is disposed on the substrate 110 and located in the display region 112, wherein the touch unit 120 is a capacitance touch unit, a resistance touch unit, an optical touch unit, a sound wave touch unit or an electromagnetic touch unit, for example. The touch display panel 100a can select the type of touch unit 120 as required. The display unit 125 is disposed on the touch unit 120 and located in the display region 112 of the substrate 110, wherein the display region 125 is a liquid crystal display screen or a touch sensing screen, for example, but the present invention is not limited thereto. The circuit film 130 is disposed on the substrate 110 and located in the peripheral region 114. The circuit film 130 is electrically connected to the touch unit 120. The flexible circuit board 140 is electrically connected to the touch unit 120 and the circuit film 130, so that the touch display panel 100a may be electrically connected to an external circuit (not shown) via the flexible circuit board 140. The substrate 110 of the embodiment is a flexible substrate so that the substrate 110 and the flexible circuit board 140 can be simultaneously fabricated. However, in other embodiments of the present invention, the substrate 110 can be a rigid substrate, and it is not limited thereto.

Specifically, the circuit film 130 has a plurality of key patterns 132, wherein the key patterns 132 include number patterns 132a, alphabet patterns 132b or symbol patterns 132c. Herein, the number patterns 132a, the alphabet patterns 132b or the symbol patterns 132c are respectively disposed on the circuit film 130. However, the touch display panel 100a can adjust the disposing locations of the number patterns 132a, alphabet patterns 132b or symbol patterns 132c on the circuit film 130, and the type and quantity of key patterns 132 can also be adjusted, herein the present invention is not limited.

In addition, the circuit film 130 has a plurality of conductive wires 134. The conductive wires 134 are electrically connected between the touch unit 120 and the flexible circuit board 140, between the touch unit 120 and the key patterns 132, and between the key patterns 132 and the flexible circuit board 140. Herein, the conductive wires 134 of the embodiment can be formed on the circuit film 130 by utilizing a printing method.

The touch display panel 100a of the embodiment has the touch unit 120 and the display unit 125 disposed in the display region 112 of the substrate 110 and the circuit film 130 disposed in the peripheral region 114 of the substrate 110. Namely, the touch display panel 100a of the embodiment integrates different types of operating interfaces on the same substrate. Therefore, the touch display panel 100a of the embodiment has both display interface and operating interface to satisfy with the real requirements of applications, and the complexity and fabricating cost of the production of touch display panel 100a can also be reduced.

The following embodiment uses the same reference numerals of the above mentioned embodiment for similar components, wherein the same reference numeral represents the same or similar component, and repeated description is omitted. For the omitted portions please refer to the above mentioned embodiment, and the following embodiment may not repeat thereafter.

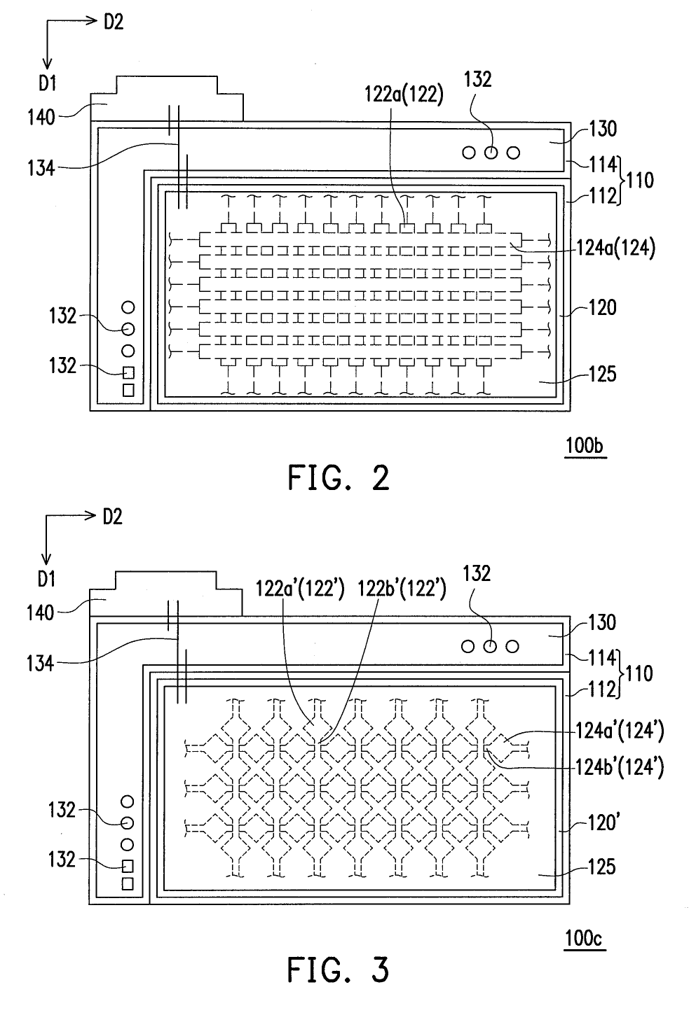

FIG. 2 is a schematic view of a touch display panel according to another exemplary embodiment of the present invention. Referring to FIG. 2, the difference between the touch display panel 100b of the present embodiment and the touch display panel 100a of the previous embodiment is that the touch unit 120 of the present embodiment is a capacitance touch unit, wherein the touch unit 120 includes a plurality of first sensing series 122 and a plurality of second sensing series 124. The first sensing series 122 are arranged in a first direction D1. The second sensing series 124 do not contact the first sensing series 122 and arranged in a second direction D2, and the first direction D1 and the second direction D2 are intersected.

More specifically, in the embodiment, each of the first sensing series 122 includes a first stripe electrode 122a, and each of the second sensing series 124 includes a second stripe electrode 124a. The first stripe electrodes 122a and the second stripe electrodes 124a do not contact each other, so as to prevent the short circuit between the conductive first stripe electrodes 122a and the conductive second stripe electrodes 124a. The first sensing series 122 and the second sensing series 124 are disposed in the display region 112 of the substrate 110, so that the touch display panel 100b has a touch sensing function. However, in other embodiments of the present invention, the first sensing series 122 and the second sensing series 124 are not limited to be stripe electrodes, that is to say, the first sensing series 122 and the second sensing series 124 may also be electrodes in other shapes.

FIG. 3 is a schematic view of a touch display panel according to another exemplary embodiment of the present invention. Referring to FIG. 3, the difference between the touch display panel 100c of the present embodiment and the touch display panel 100b of the previous embodiment is that the touch unit 120′ of the present embodiment is a capacitance touch unit and the design structure of the touch unit 120′ is different from that of the touch unit 120.

Specifically, the touch unit 120′ of the present embodiment includes a plurality of first sensing series 122′ and a plurality of second sensing series 124′. Each of the first sensing series 122′ includes a plurality of first sensing pads 122a′ and a plurality of first bridge lines 122b′ serially connecting the first sensing pads 122a′ along the first direction D1. Each of the second sensing series 124′ includes a plurality of second sensing pads 124a′ and a plurality of second bridge lines 124b′ serially connecting the second sensing pads 124a′ along the second direction D2. The first sensing series 122′ and the second sensing series 124′ do not contact each other, so as to prevent the short circuit between the conductive first sensing series 122′ and the conductive second sensing series 124′. The first sensing series 122′ and the second sensing series 124′ are disposed in the display region 112 of the substrate 110, so that the touch display panel 100c has a touch sensing function.

It should be noted that the design structure of the first sensing pads 122a′ and the second sensing pads 124a′ are not limited in the present invention. Though the shape of each of the first sensing pads 122a′ and the second sensing pads 124a′ are specified to be a rhombus, in other embodiments which are not shown in figures, the shape of each of the first sensing pads 122a′ and the second sensing pads 124a′ can be a rectangle, a circle, a triangle or any other polygon. Said embodiment still belongs to a technical means adoptable in the present invention and falls within the protection scope of the present invention.

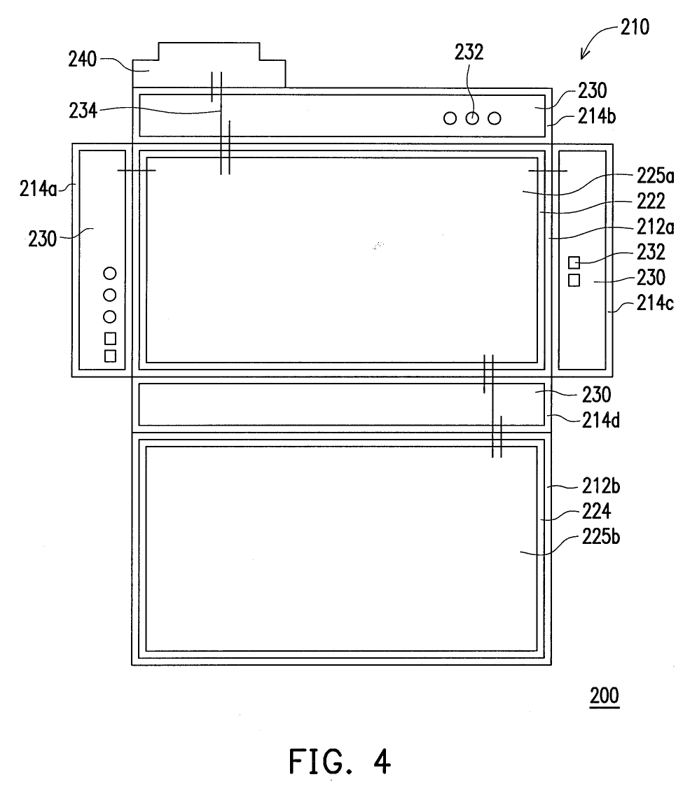

FIG. 4 is a schematic view of a touch display panel according to another exemplary embodiment of the present invention. Referring to FIG. 4, the touch display panel 200 of the embodiment includes a substrate 210, a touch unit 220, a display unit 225, a circuit film 230 and a flexible circuit board 240. The substrate 210 is a flexible substrate, wherein the substrate 210 has a display region 212 and a peripheral region 214 surrounding the display region 212. The touch unit 220 is disposed in the display region 212 of the substrate 210, and the display unit 225 is disposed on the touch unit 220 and located in the display region 212. The circuit film 230 is disposed on the substrate 210 and located in the peripheral region 214. The circuit film 230 is electrically connected to the touch unit 220. The flexible circuit board 240 is electrically connected to the touch unit 220 and the circuit film 230, so that the touch display panel 200 may be electrically connected to an external circuit (not shown) via the flexible circuit board 240.

In particular, the touch unit 220 can be a resistance touch unit, a capacitance touch unit, an optical touch unit, a sound wave touch unit or an electromagnetic touch unit, wherein the touch display panel 200 may select the type of the touch unit 220 according to the requirements. The display unit 225 is a liquid crystal display screen or a touch sensing screen, for example, but the present invention is not limited thereto. The circuit film 230 has a plurality of key patterns 232 and a plurality of conductive wires 234. The conductive wires 234 are electrically connected between the touch unit 220 and the flexible circuit board 240, between the touch unit 220 and the key patterns 232, and between the key patterns 232 and the flexible circuit board 240.

More specifically, in the embodiment, the display region 212 includes a first display region 212a and a second display region 212b. The peripheral region 214 includes a first peripheral region 214a, a second peripheral region 214b and a third peripheral region 214c which surround the first display region 212a, and a connecting region 214d connecting the first display region 212a and the second display region 212b. The touch unit 220 has a first touch unit 222 and a second touch unit 224, wherein the first touch unit 222 is disposed in the first display region 212a and the second touch unit 224 is disposed in the second display region 212b. The display unit 225 has a first display unit 225a and a second display unit 225b, wherein the first display unit 225a is disposed on the first touch region 222 and located in the first display region 212a, and the second display unit 225b is disposed on the second touch region 224 and located in the second display region 212b. It should be described that, in the embodiment, the types of the first touch unit 222 and the second touch unit 224 may be the same or not and may be selected according to application requirements. The types of the first display unit 225a and the second display unit 225b may be the same or not and may be selected according to application requirements. The circuit film 230 is disposed in the first peripheral region 214a, the second peripheral region 214b, the third peripheral region 214c and the connecting region 214d, and the circuit film 230 and the touch unit 220 are electrically connected.

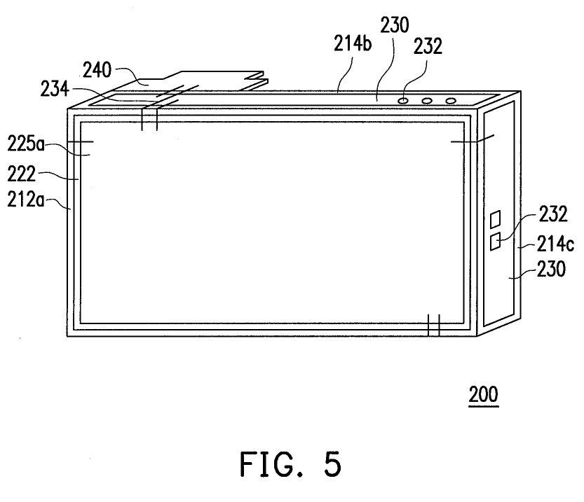

FIG. 5 schematically shows a perspective view of the touch display panel of FIG. 4. Referring to FIG. 4 and FIG. 5, in the embodiment, since the substrate 210 is flexible, the touch display panel 200 can be bent or curved to form a three-dimensional touch display panel 200. When the touch display panel 200 is bent to obtain the three-dimensional touch display panel 200, the first display region 212a and the second display region 212b are disposed back to back, and the first peripheral region 214a, the second peripheral region 214b, the third peripheral region 214c and the connecting region 214d encloses the side edges of the first display region 212a and the side edges of the second display region 212b, as shown in FIG. 5.

In light of the foregoing, the touch display panel of the embodiment of the present invention has the touch unit and the display unit disposed in the display region of the substrate and the circuit film disposed in the peripheral region of the substrate. Namely, according to the touch display panel of the embodiment of the invention, different types of operating interfaces are integrated on the same substrate. Therefore, the touch display panel of the present invention has both display interface and operating interface to satisfy with the requirements of applications, and the complexity and fabricating cost of the production of touch display panel can also be reduced.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A touch display panel, comprising:
a substrate having a display region and a peripheral region surrounding the display region;
a touch unit disposed on the substrate and located in the display region;
a display unit disposed on the touch unit and located in the display region of the substrate;
a circuit film disposed on the substrate and located in the peripheral region, wherein the circuit film is electrically connected to the touch unit, and the circuit film has a plurality of key patterns; and
a flexible circuit board electrically connected to the touch unit and the circuit film.

2. The touch display panel as claimed in claim 1, wherein the touch unit comprises a capacitance touch unit, a resistance touch unit, an optical touch unit, a sound wave touch unit or an electromagnetic touch unit.

3. The touch display panel as claimed in claim 2, wherein the capacitance touch unit comprises a plurality of first sensing series and a plurality of second sensing series, the first sensing series are arranged in a first direction, the second sensing series do not contact the first sensing series and arranged in a second direction, and the first direction and the second direction are intersected.

4. The touch display panel as claimed in claim 3, wherein each of the first sensing series comprises a first stripe electrode, and each of the second sensing series comprises a second stripe electrode.

5. The touch display panel as claimed in claim 3, wherein each of the first sensing series comprises a plurality of first sensing pads and a plurality of first bridge lines serially connecting the first sensing pads along the first direction, and each of the second sensing series comprises a plurality of second sensing pads and a plurality of second bridge lines serially connecting the second sensing pads along the second direction.

6. The touch display panel as claimed in claim 1, wherein the circuit film further has a plurality of conductive wires, the conductive wires are electrically connected between the touch unit and the flexible circuit board, between the touch unit and the key patterns, and between the key patterns and the flexible circuit board.

7. The touch display panel as claimed in claim 6, wherein the conductive wires are formed by utilizing a printing method.

8. The touch display panel as claimed in claim 1, wherein each of the key patterns comprises a number pattern, an alphabet pattern or a symbol pattern.

9. The touch display panel as claimed in claim 1, wherein the substrate comprises a flexible substrate or a rigid substrate.

10. The touch display panel as claimed in claim 9, wherein the display region of the flexible substrate comprises a first display region and a second display region, the peripheral region of the flexible substrate comprises a first peripheral region, a second peripheral region and a third peripheral region which surround the first display region, and a connecting region connecting the first display region and the second display region, the first display region and the second display region are disposed back to back, the first peripheral region, the second peripheral region, the third peripheral region and the connecting region encloses side edges of the first display region and side edges of the second display region.
